(19) United States
(12) Patent Application Publication
(10) Pub. No.: US 2014/0002595 A1
(43) Pub. Date: Jan. 2, 2014

(54) APPARATUS, SYSTEM AND METHOD FOR FOREGROUND BIASED DEPTH MAP REFINEMENT METHOD FOR DIBR VIEW SYNTHESIS

(71) Applicants: Lai Man Po, Tsing Yi (HK); Xuyuan Xu, Tai (HK); Junyan Ren, Kowloon City (HK)

(72) Inventors: Lai Man Po, Tsing Yi (HK); Xuyuan Xu, Tai (HK); Junyan Ren, Kowloon City (HK)

(73) Assignee: Hong Kong Applied Science and Technology Research Institute Co., Ltd., Shatin (HK)

(21) Appl. No.: 13/538,992

(22) Filed: Jun. 29, 2012

(51) Int. Cl. H04N 13/00

(52) U.S. Cl. 348/43; 348/E13.002

(57) ABSTRACT

The present embodiments include methods, systems, and apparatuses for foreground biased depth map refinement in which horizontal gradient of the texture edge in color image is used to guide the shifting of the foreground depth pixels around the large depth discontinuities in order to make the whole texture edge pixels assigned with foreground depth values. In such an embodiment, only background information may be used in hole-filling process. Such embodiments may significantly improve the quality of the synthesized view by avoiding incorrect use of foreground texture information in hole-filling. Additionally, the depth map quality may not be significantly degraded when such methods are used for hole-filling.

### TECHNICAL FIELD

The present invention relates generally to image processing and, more particularly, to apparatuses, systems, and methods for foreground biased depth map refinement method for Depth Image Based Rendering (“DIBR”) View Synthesis.

### BACKGROUND OF THE INVENTION

Video-plus-depth format is an efficient way to represent 3D video. This format typically includes 2D color texture video and depth map with per pixel depth information. This is a very compact format, which has been especially suitable for mobile 3D video applications. Moreover, video-plus-depth format has high feasibility to render views with variable baseline by DIBR. Thus, stereo video and multiview video can be generated for stereoscopic or auto-stereoscopic 3D display devices using such methods.

Synthesizing new views using DIBR involves three major steps: (1) depth map preprocessing, (2) 3D image warping, and (3) hole filling. One challenge to synthesize high quality virtual views is to reconstruct the large disoccluded areas after the 3D image warping process. For example, as illustrated in FIG. 1, disoccluded regions 110 may occur in areas where nearer objects 104 obscure further objects 106 from a reference view 102, but those obstructions are removed when the image is viewed from a target view 108. The disoccluded regions after the warping process are called holes. They do not exist in the 2D texture image but are exposed in the synthesized view.

For example, as shown in FIGS. 1A-1B, the 3D image may be viewed from a variety of angles. At each of the various angles, the view of the 3D image may be different because of the change in perspective. The 2D image alone may not contain sufficient information to fill in all details for each of the perspectives. Moreover, typical depth maps may not contain sufficient information to fill disoccluded regions. Disoccluded regions most often occur in background portions of 3D images.

Common methods for filling disoccluded regions include linear interpolation and depth-aid horizontal extrapolation methods. Unfortunately, both of these methods generally leave artifacts or unwanted degredation of the image, which can be very annoying to a viewer of the image. Other hole-filling methods include multidirectional extrapolation and image inpainting. These methods analyze the surrounding texture information in the image and use that information to fill the holes in the synthesized views. Unfortunately, these hole-filling method also produce annoying artifacts. The main reason is that the disocclusion regions normally involve large depth discontinuities. Thus, the hole-filling techniques that only consider the planar image information cannot solve the problem.

Artifacts in the synthesized views using depth map information are mainly due to low depth map quality associated with incorrect depth values, especially for texture edge pixels that include foreground and background color pixels. In addition, object edges may be fuzzy and contain transitional edge pixels. Consequently, unprocessed depth map usually cause artifacts after the hole filling process. These artifacts are commonly due to the fact that transitional edge pixels are mapped to background regions in the image warping process and these pixels' information are then used to fill up the holes.

One approach to depth map improvement is to use the smoothing filters such as average filtering, Gaussian filtering, asymmetric filtering and/or adaptive filtering to blur the boundaries of depth map in order to eliminate holes or reduce the sizes of the large holes. The artifacts created in such hole-filling processes may be reduced, but the depth map may be highly degraded. The highly degraded depth map may cause a poverty of 3D perception of the synthesized view.

Another approach, called reliability-based approach, uses reliable warping information from other views to fill up holes and remove the artifacts. This method requires more than one view to solve this problem and is not suitable for the view synthesis with single texture video such as video-plus-depth based DIBR applications.

### BRIEF SUMMARY OF THE INVENTION

The present embodiments include methods, systems, and apparatuses for foreground biased depth map refinement in which horizontal gradient of the texture edge in color image is used to guide the shifting of the foreground depth pixels around the large depth discontinuities in order to make the whole texture edge pixels assigned with foreground depth values. In such an embodiment, only background information may be used in hole-filling process. Such embodiments may significantly improve the quality of the synthesized view by avoiding incorrect use of foreground texture information in hole-filling. Additionally, the depth map quality may not be significantly degraded when such methods are used for hole-filling.

Embodiments of a method for foreground biased depth map refinement for use in DIBR view synthesis are presented. In one embodiment, the method includes receiving texture information associated with a plurality of pixels in a video frame. The method may also include receiving depth information associated with the plurality of pixels in the video frame. Additionally, the method may include computing a gradient value associated with a change in the texture between a subset of the plurality of pixels in the video frame, and refining the depth information associated with the subset of the plurality of pixels in the video frame in response to the gradient value. In a further embodiment, refining the depth information may include adjusting the depth information to correspond to a value associated with a foreground portion of the video frame.

The method may also include calculating a depth difference value between two or more of the plurality of pixels in the video frame and comparing the depth difference value with a depth difference threshold, wherein computing the gradient value is performed in response to a determination that the depth difference value is greater than the depth difference threshold. Calculating the depth difference value may be performed for each of a plurality of pixels in a horizontal line of pixels in the video frame and for each of the plurality of pixels in a set of horizontal lines comprising the video frame.

Embodiments of the method may also include comparing the gradient value with a gradient threshold, wherein refining the depth information for each pixel is performed in response to a determination that the gradient value is greater than the gradient threshold. The texture information may include one or more color components. Alternatively, the texture information comprises one or more grayscale components. The depth information comprises a depth pixel in a depth map.

Embodiments of a system for foreground biased depth map refinement for use in DIBR view synthesis are also presented. In one embodiment, the system includes an input device configured to receive texture information and depth information associated with a plurality of pixels in a video frame. The system may also include a processor coupled to the input device. The processor may compute a gradient value associated with a change in the texture between a subset of the plurality of pixels in the video frame, and refine the depth information associated with the subset of the plurality of pixels in the video frame in response to the gradient value.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a schematic diagram illustrating one embodiment of an image viewing scenario in which disoccluded regions occur.

FIG. 2A illustrates color pixel intensity values and depth values for a horizontal line in a video-plus-depth image format with depth edges aligned at the texture edge.

FIG. 2B illustrates the color pixel intensity values after 3D image warping.

FIG. 2C illustrates the effect of hole filling from neighboring pixels using depth-aid horizontal extrapolation hole-filling methods and resulting artifact.

FIG. 2D illustrates the effect of hole filling with pixels from the frame of neighbor views.

FIG. 3A illustrates color intensity values and depth values for a horizontal line in video-plus-depth image format with depth edges align at the background regions.

FIG. 3B illustrates color pixels after 3D image warping based upon the depth information of FIG. 3A.

FIG. 3C illustrates the effect of hole filling from neighboring pixels using depth-aid horizontal extrapolation hole filling methods and related artifact.

FIG. 3D illustrates the effect of hole filling with pixels from the frame of neighbor views.

FIG. 4 illustrates one embodiment of a system that may be suitably configured to perform methods of foreground biased depth map refinement method for DIBR View Synthesis.

FIG. 5 illustrates one embodiment of DIBR image processing modules that may be suitably configured to perform methods of foreground biased depth map refinement method for DIBR View Synthesis.

FIG. 6 is a schematic flowchart diagram illustrating one embodiment of a method for foreground biased depth map refinement method for DIBR View Synthesis.

FIG. 7A illustrates Color pixel intensity values and refined depth values for a horizontal line in video-plus-depth image format.

FIG. 7B illustrates the color pixels of FIG. 7A after 3D image warping.

FIG. 7C illustrates the effect of hole filling from neighbor pixels using depth-aid horizontal extrapolation method.

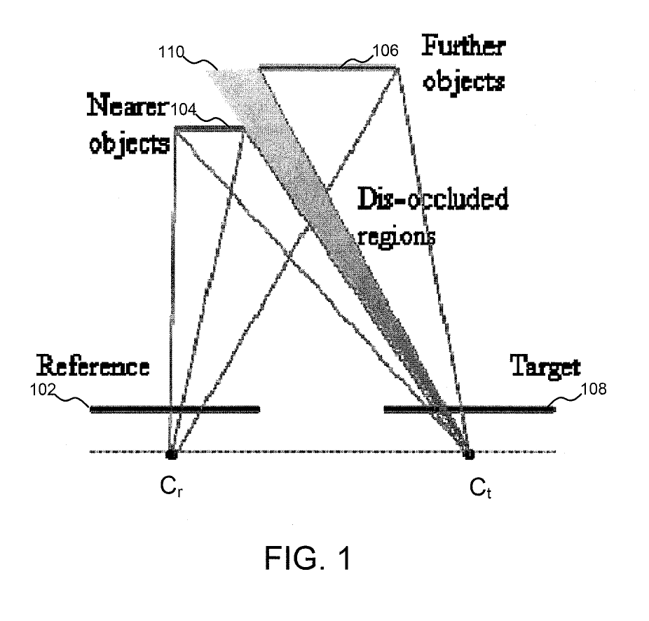

### DETAILED DESCRIPTION OF THE INVENTION

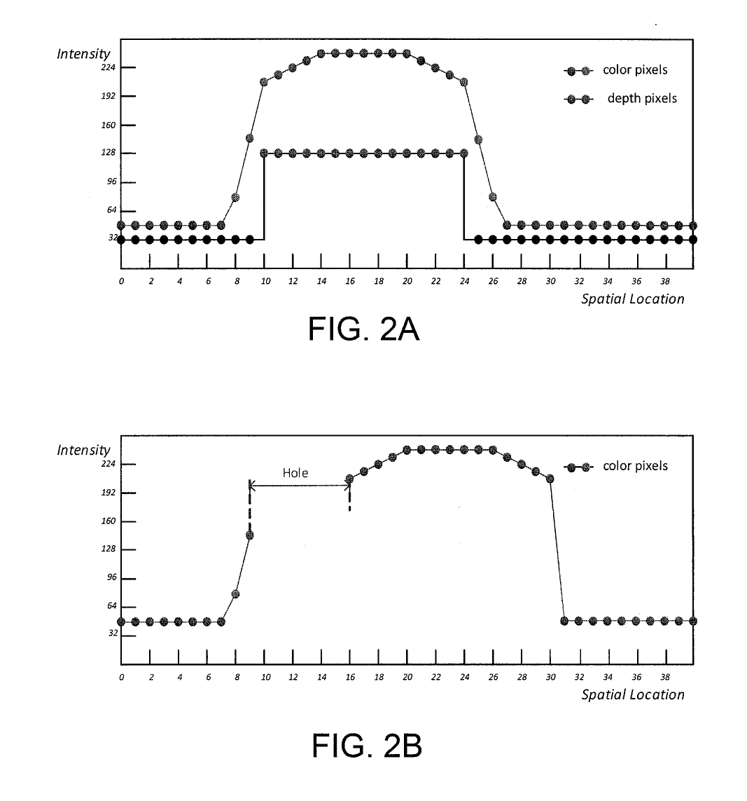

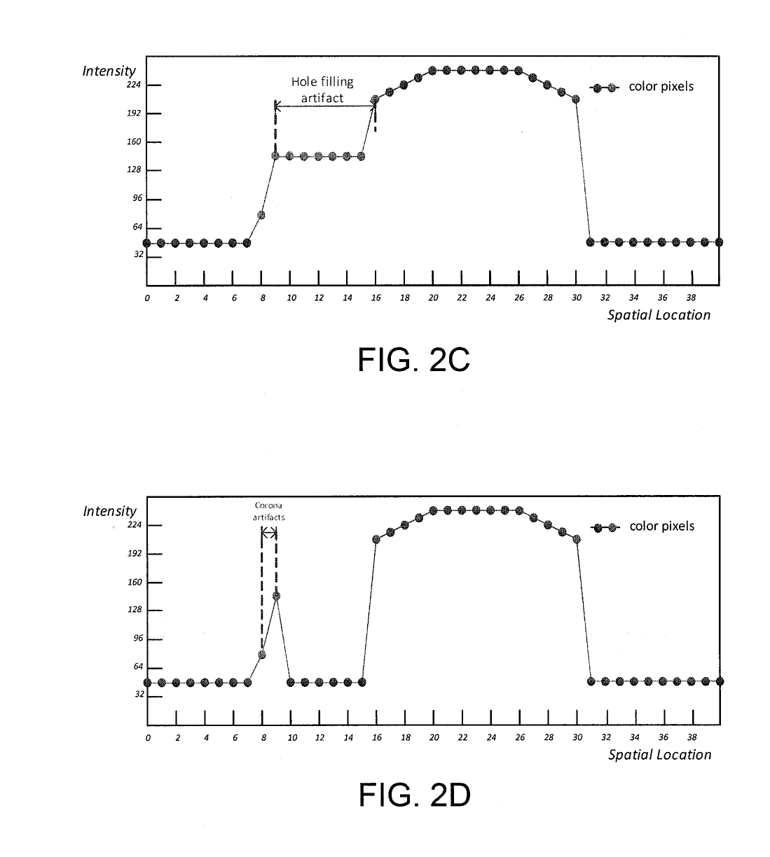

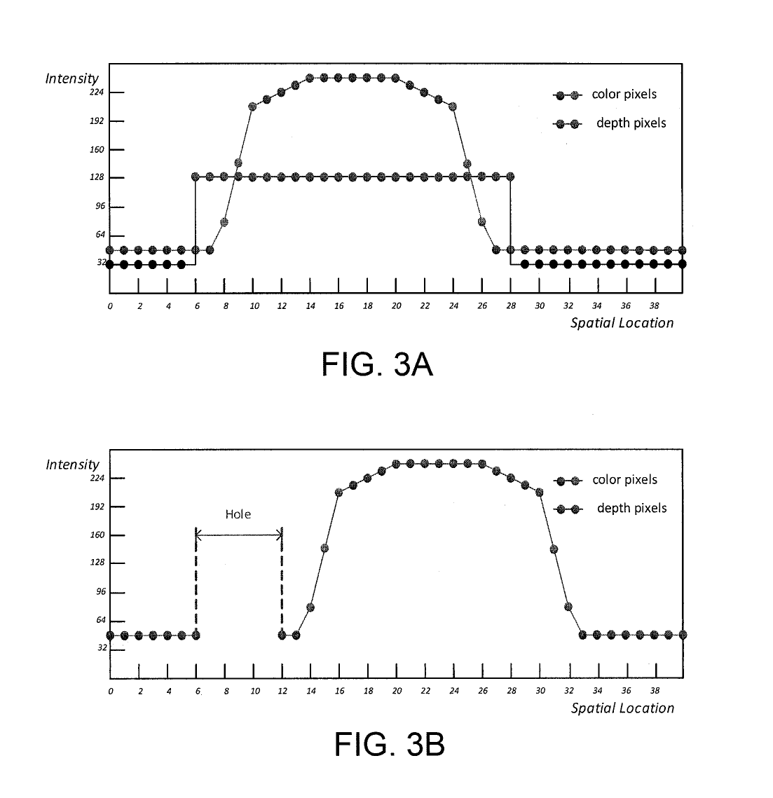

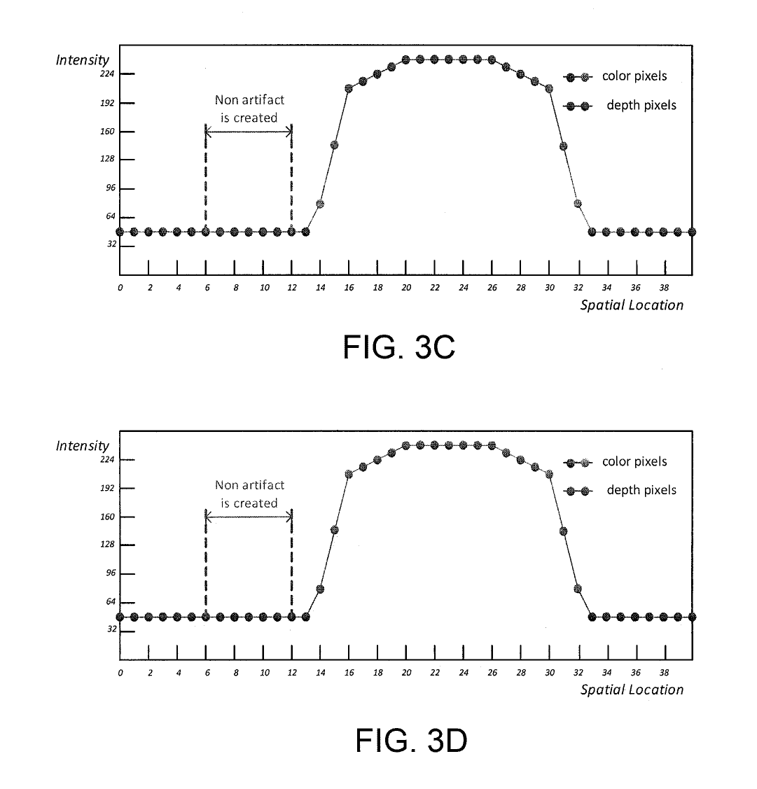

Characteristics of depth map and natural color image have many differences. Depth map represents distance between an object and a camera as a gray that has large homogeneous regions within scene objects and sudden changes of depth values at object boundaries. Thus, the edges of depth map are typically very sharp. However, most of the edges in color image are changing smoothly over a transition region. To illustrate these differences, FIG. 2A shows color pixel intensive values and depth pixel values of a horizontal line in a color image. There are two smooth edges of an object with sharp depth edges in the corresponding depth map. In the case of FIG. 2A, these two depth object boundaries are aligned at the middle of the transitional color edges. However, depth map that captured by depth camera or estimated from video frames may not aligned correctly. These depth edges may be misaligned at the foreground regions or background regions as shown in FIG. 3A and FIG. 3B, respectively. We found that the annoying hole-filling artifacts of the DIBR based synthesized views are highly affected by the alignment between depth map and color image. This is mainly due to the fact that object boundaries contain a combination of foreground and background color information. Incorrect depth values may assign to these edge pixels such that foreground color pixels or transitional edge pixels with similar foreground colors are treated as the background pixels. In the hole filling process, these background pixels with color more similar to the foreground objects are used to fill up the hole regions, which creating annoying artifacts. This is also the cause of the corona artifacts of the synthesized view for filling up the holes using the pixels from the frames of neighbor views.

To illustrate this phenomenon, the example of FIG. 2A with the depth edges that located at the middle of the transitional regions of the color edges is first used to describe how the holes and artifacts are created during the 3D image warping and hole fill processes of the DIBR. FIG. 2B shows the pixel line of the synthesized left view with a large hole that created after the 3D image warping process. In which the background pixels and part of the transitional edge pixels are shifted to left and a large hole is created. In DIBR based view synthesis using one texture image, this hole is filled with the neighbor background pixels and FIG. 2C shows the effect of filling up this hole using depth-aid horizontal extrapolation method. In which color pixels with low depth values are preferred to fill up the holes. Then, the hole is filled with a color of the transitional edge pixels, which creates the annoying hole filling artifact. If this hole is filled with the pixels from the frame of neighbor views, corner artifact is created as shown in FIG. 2A. More annoying artifacts may be caused, if the depth edges are misaligned in the foreground regions. It is because the colors of the foreground pixels are more dissimilar to the color of the pixels in the transitional edge regions. However, if the depth edges are misaligned in the background regions, the artifacts may not be very serious as shown in example of FIGS. 3A-3D. It is because the whole transitional edges are mapped to the foreground regions in the synthesized view as shown in FIG. 3C after 3D image warping. In addition, the holes are created in the background regions, then the holes have much higher chances to be filled up with pixels that similar to background regions as shown in FIG. 3D.

Based on the above observations, if the depth map can be refined in the preprocessing stage for fixing the misalignment problem with the foreground region to cover the whole transitional region of texture edges, the annoying hole filling artifacts should be significantly minimized in the synthesized views. Based on this idea, a foreground biased depth map refinement is disclosed for refining the sharp depth edges positions to the background regions based on the horizontal gradient of corresponding edges in color image.

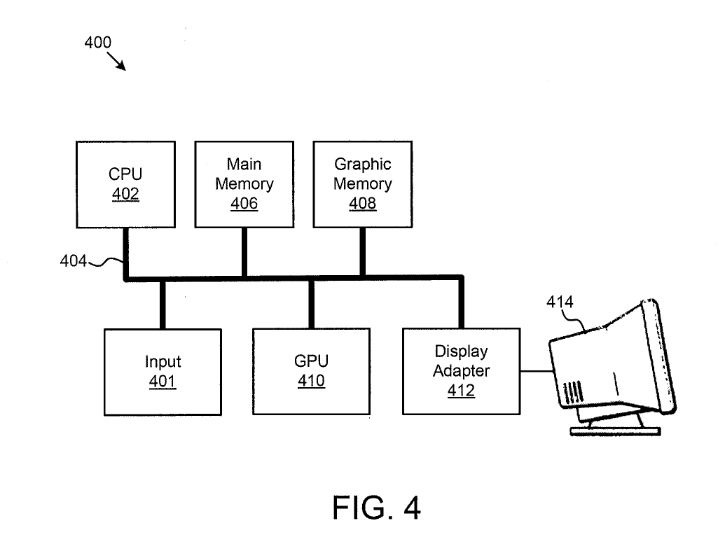

FIG. 4 illustrates one embodiment of system 400 for foreground biased depth map refinement method for DIBR View Synthesis. In one embodiment, system 400 includes Central Processing Unit 406 (CPU), main memory device 406, graphic memory device 408, and Graphics Processing Unit 410 (GPU). These components may be coupled to input 401 and display adapter 412 by bus 404 or other suitable data connection. In a further embodiment, display adapter 412 may be configured to cause an output video to be displayed on display device 414. One of ordinary skill in the art will recognize a variety of device configurations of system 400 that may be suitably adapted for use with the present embodiments. In one embodiment computer readable instructions, comprising computer code may be stored in main memory 406 and executed by CPU 402 to cause CPU 402 to perform operations of the methods foreground biased depth map refinement method for DIBR View Synthesis as described herein. Alternatively, the code may be stored in graphics memory 408 and executed by GPU 410. In a further embodiment, graphics memory 408 and GPU 410 may be integrated on a video or graphics card.

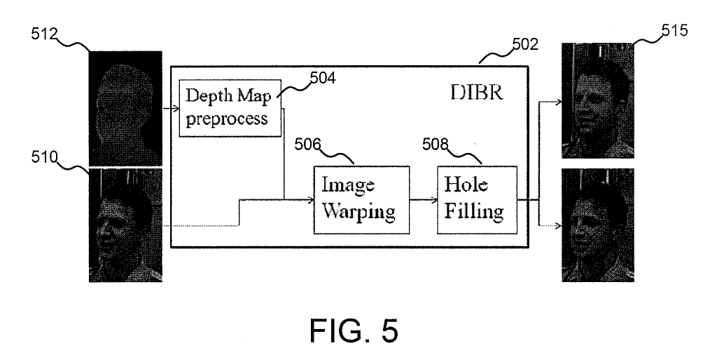

FIG. 5 Illustrates one embodiment of DIBR module 502 that may be implemented by either CPU 402 or GPU 410. Alternatively, DIBR module 502 may be implemented in hardware, for example in an Application-Specific Integrated Chip (ASIC). In the depicted embodiment, DIBR module 502 includes depth map preprocessor 504, image warping module 506, and hole filling module 508. Embodiments of these modules may be configured according to carry out operations for performing embodiments of a method for foreground biased depth map refinement method for DIBR View Synthesis.

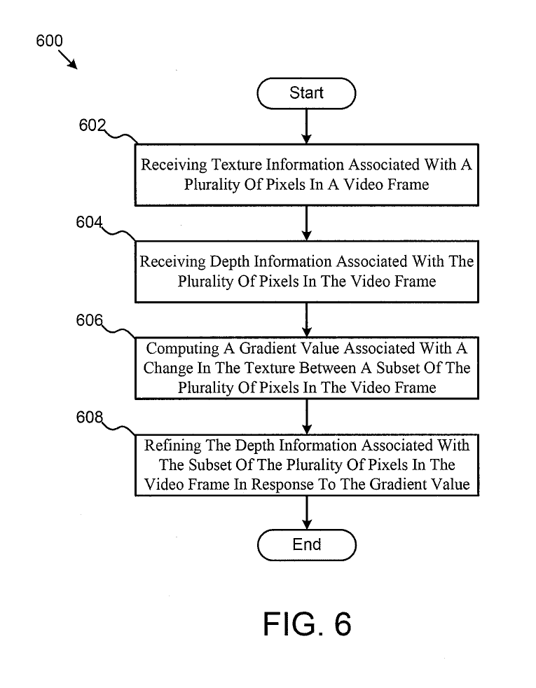

For example, as illustrated in FIG. 6, DIBR module 502 may be configured to carry out method 600. Method 600 starts when input 401 receives texture information associated with a plurality of pixels in a video frame at block 602. In addition, at block 604 input module 401 may receive depth information associated with the plurality of pixels in the video frame. Depth map preprocessor 504 may compute a gradient value associated with a change in the texture between a subset of the plurality of pixels in the video frame as shown at block 606. Depth map preprocessor 504 may further refine the depth information associated with the subset of the plurality of pixels in the video frame in response to the gradient value as shown in block 608.

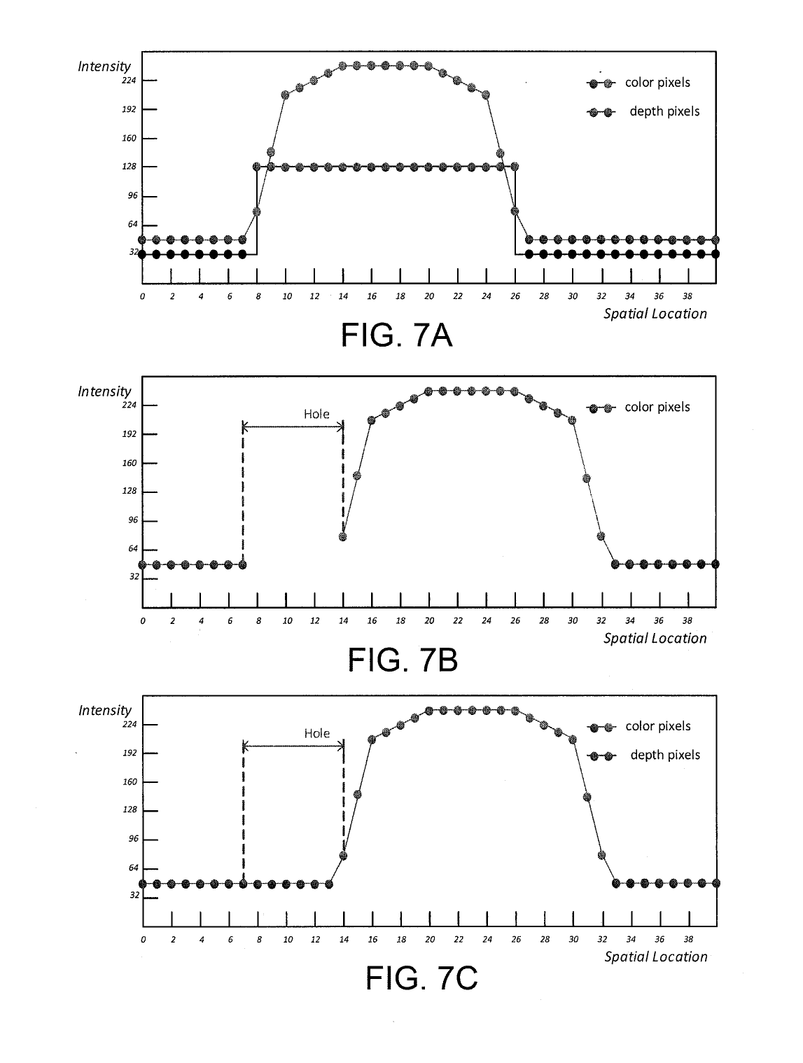

If the depth map can be refined in the preprocessing stage with the foreground region to cover the whole transitional region of texture edges, the annoying hole filling artifacts may be significantly minimized in the synthesized views. In such an embodiment, the depth values of these transitional edge pixels are refined in order to make them become foreground pixels as shown in FIG. 7A. After 3D warping, the whole texture edges are mapped to the foreground region as shown in FIG. 7B. The artifacts can be significantly minimized after hole filling as shown in FIG. 7C.

In one embodiment, only the depth values of transitional edge pixels with large depth discontinuity are refined. Although the boundary artifacts appear around object boundaries, gradually changing depth values does not generate annoying artifacts since small depth discontinuities create only very small holes in the warped image. Artifacts are only observed in the large holes. In one embodiment, a pre-defined depth threshold is used to trigger the refinement process and this depth discontinuity threshold is derived based on the relationship of the hole's size with the depth values difference. The relationship between hole's size and depth values difference between two horizontal adjacent pixels based on shift-sensor model for DIBR may be devised as

$$Δ d = \frac{h}{\text{?}} \cdot \frac{1}{( \frac{1}{255 {z}_{n}} - \frac{1}{255 {z}_{f}} )} \\ \text{?} \text{indicates text missing or illegible when filed} \qquad ( 1 )$$

where Δd is the depth values difference between two horizontal adjacent depth pixels, t_{c} and f are the baseline distance and the focal length, respectively. The zₙ and z_{f} represent the nearest distance and the farthest distance in the scene. In the proposed algorithm, hole's sizes greater or equal to 3 (h≧3) are classified as large holes. Thus, the pre-defined depth discontinuity threshold T_{d} is given by

$${T}_{d} = \frac{3}{{t}_{c} f} \cdot \frac{1}{( \frac{1}{255 {z}_{n}} - \frac{1}{255 {z}_{f}} )} \qquad ( 2 )$$

For any absolute depth values difference larger than T_{d}, the hole's size in warped image will be larger than 3 pixels and the proposed foreground biased depth refinement will be performed around neighborhood's depth pixels.

The proposed refinement method is a line-by-line process aiming at extending the foreground depth values to cover the whole transitional region of texture edges based on the horizontal gradient at the color edges. The refinement process is triggered by the horizontal depth values changing from low to high with the difference larger than the pre-defined depth threshold T_{d}(dᵢ−dᵢ₊₁<−T_{d}), which similar to the sharp depth edge on the left side of FIG. 2A. The proposed refinement process will shift the foreground depth value to left side (setting dᵢ=dᵢ₊₁) if the horizontal gradient of the texture edge is greater than a pre-defined gradient threshold Gₕ. This shifting process is repeated until the texture edge gradient is not greater than the gradient threshold or the shifting is larger than a pre-defined window size W. This window size is used to avoid over shifting of the foreground depth pixels. Many well-known horizontal gradient operators can be used in this process. Our experimental results are all based Prewitt operator and the window size W is set to 5. For the example as shown in FIG. 2A, when the sharp depth edge is on the left side, the depth values will be shifted to the left by two pixel with the resulting depth values as shown in FIG. 7A.

The refinement process is also triggered by the horizontal depth values change from high to low with the depth difference larger than the pre-defined depth threshold T_{d}(dᵢ−dᵢ₊₁>T_{d}) similar to the sharp depth edge on the right side of FIG. 2A. The proposed refinement process will shift the foreground depth values to right side (setting dᵢ₊₁=dᵢ) if the horizontal gradient of the texture edge is greater than the gradient threshold Gₕ. For the example as shown in FIG. 2A, when the sharp depth edge is on the right, the depth values will be shifted to the right by two pixel and the refined depth values are shown in FIG. 7A. The two transitional texture edges are assigned with the foreground depth values. Then, the artifacts are significantly reduced due to the use of background pixels for hole filling.

One of the possible implementation of the proposed foreground biased depth refinement algorithm can be summarized as the following steps:
(1) Set j=0 and input the first horizontal line of the depth map
(2) Set dᵢ with i=0, 1, 2, . . . , N−1 as the depth values of the j horizontal line of the depth map
(3) Set i=0
(4) Calculate the depth value difference of D=dᵢ−dᵢ₊₁
(5) If D<−T_{d} then
   (5.1) Set k=0
   (5.2) Calculate the horizontal gradient of the color pixels at (j, i+k) as G_{j, i+k}
   (5.3) If G_{j, i+k}>Gₕ then
      (5.3.1) Set dᵢ₊ₖ=dᵢ₊ₖ₊ₗ and Set k=k−1
      (5.3.2) If k>−W, then go to Step (5.2)
(6) If D>T_{d} then
   (6.1) Set k=0
   (6.2) Calculate the horizontal gradient of the color pixel at (j, i+k) as G_{j, i+k}
   (6.3) If G_{j, i+k}>Gₕ then
      (6.3.1) Set dᵢ₊ₖ₊ₗ=dᵢ₊ₖ and Set k=k+1
      (6.3.2) If k<W, then go to Step (6.2)
(7) If i<N, then Set i=i+1 and go to Step (4)
(8) If i=N, then Set j=j+1

(9) If j<M, then input next horizontal line of the depth map and go to Step (2)

(10) End of the process

In the pseudo code described above, i is horizontal position on the line, j is a line in image, j=0 is first line in image. D is a depth difference value, and dᵢ represents the depth value of each pixel in the line. Step 5 describes a left-hand side shifting method, and step 6 above describes a right-hand side shifting method. T_{d} is depth threshold. It is negative because we are moving from low to high depth values. The variable k is an index for shifting, and k defines the number of shifts of the depth map to cover the entire foreground. The variable G_{j, i+k} represents the gradient between pixel j and pixel i+k, and Gₕ is the gradient threshold. So if the gradient is bigger than the threshold, then shift. Optionally, the amount of shifting may be limited by setting a shifting window to avoid over-shifting using the W operator. N describes a maximum number of pixels on each line, which can be used to see if the last pixel in the line has been reached. M is the total number of lines in the image, which can be used to see if the last line in the image has been reached.

To further simplify the depth map refinement process, only low to high or high to low refinement process is applied for synthesizing the virtual left or right view in the DIBR process. The proposed method can be extended to the general case of 3D image warping process with a small modification. We can replace the method of finding large hole of comparing depth difference with threshold by checking the depth values of neighbor pixels that create larger hole in the warping process. Thus, the proposed method can be easily integrated into the DIBR based 3D image/video systems.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for foreground biased depth map refinement for use in Depth Image Based Rendering (“DIBR”) view synthesis comprising:
receiving texture information associated with a plurality of pixels in a video frame;
receiving depth information associated with the plurality of pixels in the video frame;
computing a gradient value associated with a change in the texture between a subset of the plurality of pixels in the video frame; and
refining the depth information associated with the subset of the plurality of pixels in the video frame in response to the gradient value.

2. The method of claim 1, wherein refining the depth information comprises adjusting the depth information to correspond to a value associated with a foreground portion of the video frame.

3. The method of claim 1, further comprising calculating a depth difference value between two or more of the plurality of pixels in the video frame.

4. The method of claim 3, further comprising comparing the depth difference value with a depth difference threshold, wherein computing the gradient value is performed in response to a determination that the depth difference value is greater than the depth difference threshold.

5. The method of claim 3, wherein calculating the depth difference value is performed for each of a plurality of pixels in a horizontal line of pixels in the video frame.

6. The method of claim 5, wherein calculating the depth difference value is performed for each of the plurality of pixels in a set of horizontal lines comprising the video frame.

7. The method of claim 1, further comprising comparing the gradient value with a gradient threshold, wherein refining the depth information for each pixel is performed in response to a determination that the gradient value is greater than the gradient threshold.

8. The method of claim 1, wherein the texture information comprises one or more color components.

9. The method of claim 1, wherein the texture information comprises one or more grayscale components.

10. The method of claim 1, wherein the depth information comprises a depth pixel in a depth map.

11. A system for foreground biased depth map refinement for use in Depth Image Based Rendering (“DIBR”) view synthesis comprising:
an input device configured to receive texture information and depth information associated with a plurality of pixels in a video frame; and
a processor coupled to the input device, the processor configured to:
compute a gradient value associated with a change in the texture between a subset of the plurality of pixels in the video frame; and
refine the depth information associated with the subset of the plurality of pixels in the video frame in response to the gradient value.

12. The system of claim 11, wherein the processor is further configured to adjust the depth information to correspond to a value associated with a foreground portion of the video frame.

13. The system of claim 11, wherein the processor is further configured to calculate a depth difference value between two or more of the plurality of pixels in the video frame.

14. The system of claim 13, wherein the processor is further configured to compare the depth difference value with a depth difference threshold, wherein computing the gradient value is performed in response to a determination that the depth difference value is greater than the depth difference threshold.

15. The system of claim 13, wherein the processor is configured to calculate the depth difference value for each of a plurality of pixels in a horizontal line of pixels in the video frame.

16. The method of claim 15, wherein the processor is configured to calculate the depth difference value for each of the plurality of pixels in a set of horizontal lines comprising the video frame.

17. The system of claim 11, wherein the processor is further configured to compare the gradient value with a gradient threshold, wherein refining the depth information for each pixel is performed in response to a determination that the gradient value is greater than the gradient threshold.

18. The system of claim 11, wherein the texture information comprises one or more color components.

19. The system of claim 11, wherein the texture information comprises one or more grayscale components.

20. The system of claim 11, wherein the depth information comprises a depth pixel in a depth map.
